(19) United States
(12) Patent Application Publication
(10) Pub. No.: US 2014/0212715 A1
(43) Pub. Date: Jul. 31, 2014

(54) RECHARGEABLE BATTERY

(71) Applicants: ROBERT BOSCH GMBH, Stuttgart (DE); SAMSUNG SDI CO., LTD., Yongin-si (KR)

(72) Inventors: In KIM, Yongin-si (KR); Eun-Jung KIM, Yongin-si (KR)

(73) Assignees: ROBERT BOSCH GMBH, Stuttgart (DE); SAMSUNG SDI CO., LTD., Yongin-si (KR)

(21) Appl. No.: 13/971,979

(22) Filed: Aug. 21, 2013

(30) Foreign Application Priority Data
Jan. 31, 2013 (KR) 10-2013-0011221

(51) Int. Cl. H01M 10/04

(52) U.S. Cl. CPC H01M 10/0431
USPC 429/94

(57) ABSTRACT

A rechargeable battery includes an electrode assembly including a separator and electrode layers on opposite sides of the separator, the electrode assembly being wound such that curved surface portions are at opposing sides of the electrode assembly and a plane surface portion is between the curved surface portions, a pressing member that presses at least one part of the curved surface portions and the plane surface portion, a case containing the pressing member and the electrode assembly, and a cap plate electrically connected to the electrode assembly and coupled to the case.

### CROSS-REFERENCE TO RELATED APPLICATION

Korean Patent Application No. 10-2013-0011221 filed on Jan. 31, 2013, in the Korean Intellectual Property Office, and entitled: “RECHARGEABLE BATTERY,” is incorporated by reference herein in its entirety.

### BACKGROUND

1. Field

Embodiments relate to a rechargeable battery.

2. Description of the Related Art

A rechargeable battery can be repeatedly charged and discharged, unlike a primary battery that cannot be charged. A low capacity rechargeable battery is used for a small portable electronic device, such as a mobile phone, a laptop computer, and a camcorder, and a large capacity rechargeable battery is widely used as a power source for driving a motor, such as for a hybrid vehicle.

### SUMMARY

Embodiments are directed to a rechargeable battery including an electrode assembly including a separator and electrode layers on opposite sides of the separator, the electrode assembly being wound such that curved surface portions are at opposing sides of the electrode assembly and a plane surface portion is between the curved surface portions, a pressing member that presses at least one part of the curved surface portions and the plane surface portion, a case containing the pressing member and the electrode assembly, and a cap plate electrically connected to the electrode assembly and coupled to the case.

The electrode assembly may further include interface portions between the curved surface portions and the plane surface portion. The pressing member may further include a first pressing portion and a second pressing portion that press respective parts of the interface portions and the plane surface portion in a surface contact manner, the first pressing portion and the second pressing portion facing each other, and a support portion that connects the first pressing portion and the second pressing portion.

The pressing member may include a first pressing member coupled to a first curved surface portion at an upper portion of the electrode assembly, and a second pressing member coupled to a second curved surface portion at a lower portion of the electrode assembly.

The support portion of the first pressing member may include a through-hole that faces the first curved surface portion.

The pressing member may have a structure such that, when the first pressing portion and the second pressing portion are in a state of not pressing the respective parts of the interface portions and the plane surface portion, a distance between the first pressing portion and the second pressing portion gradually decreases as a distance from the support portion increases, and when the first pressing portion and the second pressing portions are pressing the respective parts of the interface portions and the plane surface portion, the first pressing portion and the second pressing portion form a right angle with the support portion, and thus, maintain a parallel state therebetween.

The support portion may be curved to correspond to one curved surface portion of the curved surface portions of the electrode assembly, the support portion supporting the one curved surface portion in a surface contact manner, and the support portion including a through-hole that faces the one curved surface portion.

The pressing member may have a structure such that, when the first pressing portion and the second pressing portion are in a state of not pressing the respective parts of the interface portions and the plane surface portion, a distance between the first pressing portion and the second pressing portion of the pressing member gradually decreases as a distance from the support portion increases, and when the first pressing portion and the second pressing portion are pressing the respective parts of the interface portions and each plane surface portion, the first pressing member and the second pressing member are parallel.

The first pressing portion, the support portion, and the second pressing portion may have a same thickness along the plane surface portion and the one curved surface portion.

A thickness of each of the first pressing portion, the support portion, and the second pressing portion may be gradually increased from the plane surface portion toward the one curved surface portion.

The electrode assembly may further include interface portions between the curved surface portions and the plane surface portion. The electrode assembly may be provided as a plurality of electrode assemblies. The pressing member may include a first pressing portion and a second pressing portion that press respective parts of the interface portions and plane surface portion of two electrode assemblies disposed at outermost sides among the plurality of electrode assemblies, and a support portion connecting the first pressing portion and the second pressing portion in a surface contact manner.

The pressing member may further include at least one third pressing portion connected to the support portion between the first pressing portion and the second pressing portion, the third pressing portion extending between two adjacent ones of the electrode assemblies such that two sides of the third pressing portion press facing parts of the interface portions and the plane surface portion of the adjacent ones of the electrode assemblies in a surface contact manner.

The support portion of the pressing member may include at least one through-hole that faces toward the curved surface portions of each of the plurality of electrode assemblies.

The electrode assembly may further include an interface portion between the curved surface portions and the plane surface portions. The pressing member may include a first pressing portion and a second pressing portion that respectively include inner protrusions that face toward each other and press respective parts of the interface portion, and a support portion connecting the first pressing portion and the second pressing portion.

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery according to an exemplary embodiment.

FIG. 2 illustrates a cross-sectional view of FIG. 1, taken along the line II-II.

FIG. 3 illustrates an exploded perspective view of an electrode assembly and a pressing member of FIG. 2.

FIG. 4 illustrates a cross-sectional view of FIG. 3, taken along the line IV-IV.

FIG. 5 illustrates a perspective view of a coupling state of an electrode assembly and a pressing member in a rechargeable battery according to another exemplary embodiment.

FIG. 6 illustrates a cross-sectional view of FIG. 5, taken along the line VI-VI.

FIG. 7 illustrates a cross-sectional view of a coupling state of an electrode assembly and a pressing member in a rechargeable battery according to another exemplary embodiment.

FIG. 8 illustrates a cross-sectional view of a coupling state of an electrode assembly and a pressing member in a rechargeable battery according to another exemplary embodiment.

FIG. 9 illustrates a cross-sectional view of an electrode assembly and a pressing member in a rechargeable battery according to another exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of elements may be exaggerated for clarity of illustration. Like reference numerals refer to like elements throughout.

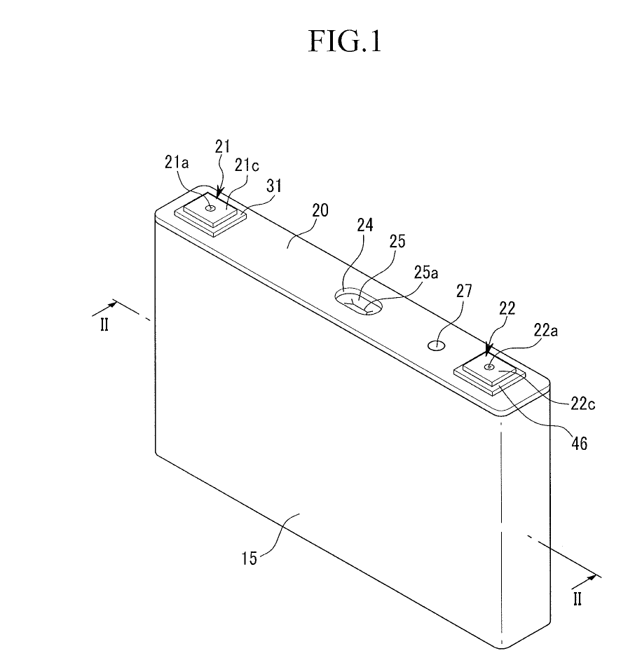

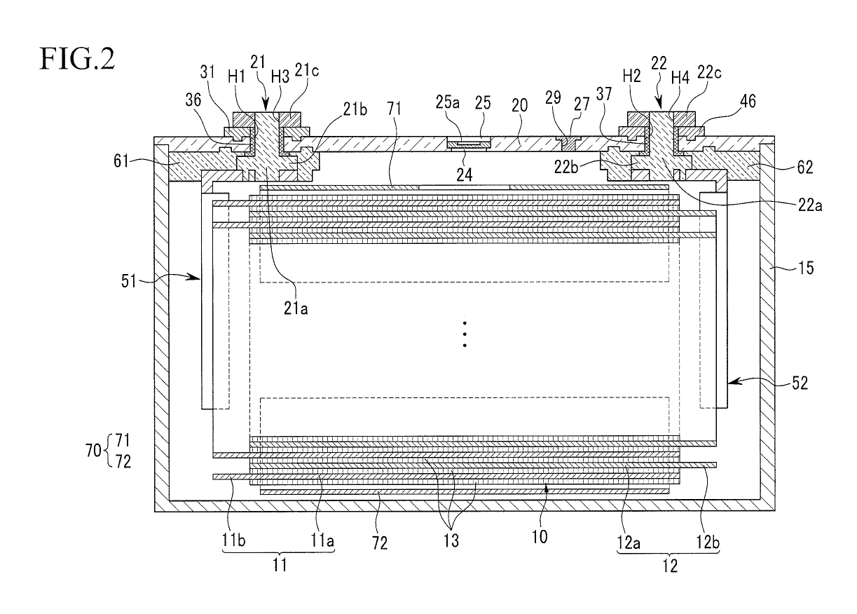

FIG. 1 illustrates a perspective view of a rechargeable battery according to an exemplary embodiment, and FIG. 2 illustrates a cross-sectional view of FIG. 1, taken along the line II-II.

Referring to FIG. 1 and FIG. 2, a rechargeable battery according to this exemplary embodiment may include an electrode assembly 10 charging and discharging a current, a pressing member 70 pressing the electrode assembly 10, a case 15 in which the electrode assembly 10 and the pressing member 70 are installed, a cap plate 20 coupled to an opening of the case 15, and electrodes (e.g., negative electrode terminal 21 and a positive electrode terminal 22) installed in the cap plate 20.

For example, the electrode assembly 10 may be formed by disposing electrodes (e.g., a negative electrode 11 and a positive electrode 12) at respective surfaces of a separator 13, which is an insulator, and spiral-winding the negative electrode 11, the separator 13, and the positive electrode 12 in a jellyroll shape.

The negative electrode 11 and the positive electrode 12 may respectively include coated regions 11a and 12a, in which an active material is coated to a current collector of a metal plate, and uncoated regions 11b and 12b, in which a current collector is exposed because an active material is not coated thereto.

The uncoated region 11b of the negative electrode 11 may be formed at one end of the negative electrode 11 along the -wound negative electrode 11. The uncoated region 12b of the positive electrode 12 may be formed at one end of the positive electrode 12 along the wound positive electrode 12. The uncoated regions 11b and 12b may be respectively disposed at both ends of the electrode assembly 10.

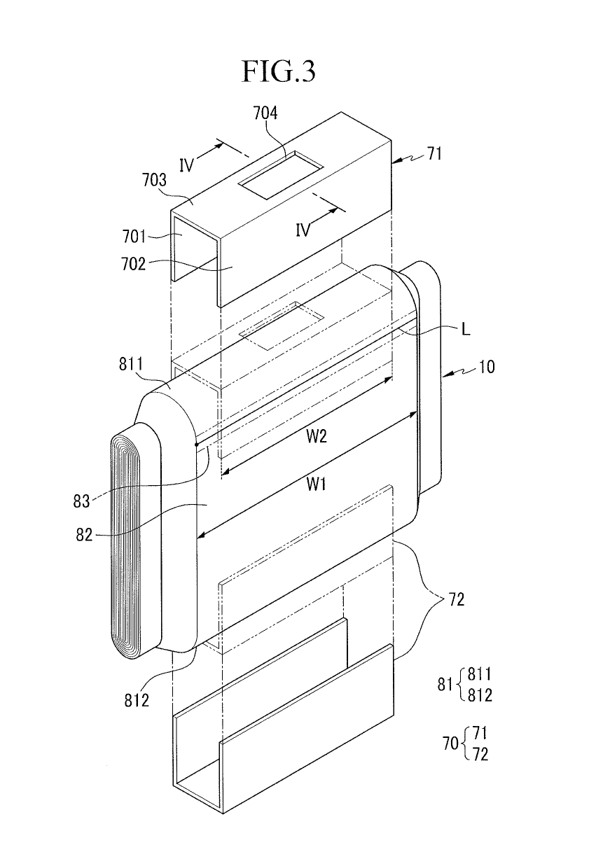

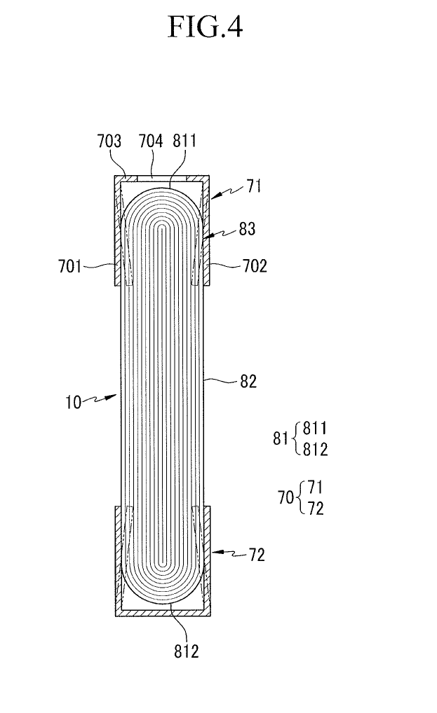

FIG. 3 illustrates an exploded perspective view of the electrode assembly 20 and the pressing member 70 of FIG. 2, and FIG. 4 illustrates a cross-sectional view of FIG. 3, taken along the line IV-IV.

Referring to FIG. 3 and FIG. 4, the electrode assembly 10 may include curved surface portions 81 (811 and 812) and a plane surface portion 82 formed between the curved surface portions 811 and 812. As can be seen in FIG. 4, the plane surface portion 82 may be present on two sides of the electrode assembly 10. The curved surface portions 811 and 812 may be formed at both sides of the electrode assembly 10 due to the spiral winding of the negative electrode 11, the separator 13, and the positive electrode 12, the negative electrode 11 and the positive electrode 12 being layered on respective sides of the separator 13. In addition, the electrode assembly 10 may further include an interface portion 83 disposed between the curved surface portions 81 and the plane surface portion 82 to form an interface therebetween.

The interface portion 83 may be in a form of a line L that connects spots where curved lines of the curved surface portions 81 and a straight line of the plane surface portion 82 meet each other in a width direction of the electrode assembly 10. The interface portion 83 may further include an area that corresponds to a set distance along the curved surface portions 81 and the plane surface portion 82 from the line L. In addition, the interface portion may be formed as a curved line or an irregularly curved line, and may further include an area that corresponds to a set distance set along the curved surface portions and the plane surface portion from the curved line.

When the pressing member 70 is not used, bonding at an interface of the separator 13 and the negative electrode 11 and bonding at an interface of the separator 13 and the positive electrode 12 may be non-uniform in at least one portion of the curved surface portions 81 and the plane surface portion 82.

The pressing member 70 presses at least one of the curved surface portions 81 and the plane surface portion 82 to make uniform the bonding that is generated in the interface of the separator 13 and the negative electrode 11 and the interface of the separator 13 and the positive electrode 12.

In addition, when the pressing member 70 is not used, bonding at the interface of the separator 13 and the negative electrode 11 and bonding at the interface of the separator 13 and the positive electrode 12, corresponding to the interface portion 83, may be non-uniform. In this case, the bonding at the interface of the separator 13 and the negative electrode 11 and the bonding at the interface of the separator 13 and the positive electrode 12 in an area corresponding to one of the curved surface portions 81 and the plane surface portion 82 may be non-uniform

The pressing member 70 may uniformize the non-uniform bonding that may be generated at the interface of the separator 14 and the negative electrode 11 and at the interface of the separator 13 and the positive electrode 12 by pressing the interface portion 83, which includes the line L and a peripheral thereof of the area of the electrode assembly 10. In this case, the pressing member 70 may further press at least one of the curved surface portions 81 and the plane surface portion 82 to uniformize the non-uniform bonding that may be generated at the interface of the separator 13 and the negative electrode 11 and at the interface of the separator 13 and the positive electrode 12.

The curved surface portions 81 of the electrode assembly 10 may include a first curved surface portion 811 set in an upper portion of the electrode assembly 10 and a second curved portion 812 set in a lower portion of the electrode assembly 10. Thus, the pressing member 70 may include a first pressing member 71 coupled to the first curved surface portion 811 disposed in the upper portion of the electrode assembly 10 and a second pressing member 72 coupled to the second curved surface portion 812 disposed in the lower portion of the electrode assembly 10.

Referring back to FIG. 1 and FIG. 2, the case 15 may be substantially formed in the shape of a cuboid to provide a space for receiving the electrode assembly 10, the pressing member 70, and an electrolyte solution therein. The case 15 may include an opening formed in one side of the cuboid to connect the outside and the internal space. The opening may enable the electrode assembly 10 to be inserted into the case 15.

The cap plate 20 may seal the case 15 by being provided in the opening of the case 15. The case 15 and the cap plate 20 may be made of aluminum so that they can be welded to each other.

In addition, the cap plate 20 may include one or more openings. For example, the cap plate 20 may include an electrolyte injection opening 29, a vent hole 24, and terminal holes H1 and H2. The electrolyte injection opening 29 may enable injection of the electrolyte solution into the case 15 after the cap plate 20 is coupled to the case 15. After injection of the electrolyte solution, the electrolyte injection opening 29 may be sealed by a sealing cap 27.

The negative terminal 21 and the positive terminal 22 may be respectively provided in the terminal holes H1 and H1 and electrically connected to the electrode assembly 10. The negative terminal 21 may be electrically connected to the negative electrode 11 of the electrode assembly 10, and the positive terminal 22 may be electrically connected to the positive electrode 12 of the electrode assembly 10. Thus, electrical power generated by the electrode assembly 10 may be drawn out to the outside of the case 15 through the negative terminal 21 and the positive terminal 22.

The negative terminal 21 and the positive terminal 22 may be formed with the same structure at the internal side the cap plate 20 and may be formed with different structures at the external side of the cap plate 20. The different structures of the negative terminal 21 and the positive terminal 22 will be respectively described and similar structures of the two terminals 21 and 22 will be described together.

The negative terminal 21 and the positive terminal 22 may include plate terminals 21c and 22c disposed at the external side of the cap plate 20, corresponding to the terminal holes H1 and H2, and rivet terminals 21a and 22a electrically connected to the electrode assembly 10 and fastened to the plate terminals 21c and 22c through the terminal holes H1 and H2.

The plate terminals 21c and 22c may have through-holes H3 and H4, respectively, and upper ends of the rivet terminals 21a and 22a extending through the terminal holes H1 and H2 may be inserted into the through-holes H3 and H4. The negative terminal 21 and the positive terminal 22 may further include flanges 21b and 22b integrally formed with the rivet terminals 21a and 22a at an inner side of the cap plate 20, the flanges 21b and 22b being wider than the rivet terminals 21a and 22a.

The negative electrode gasket 36 and the positive electrode gasket 37 may be respectively provided between the rivet terminals 21a and 22a of the negative and positive terminals 21 and 22 and the inner surfaces of the terminal holes H1 and H2 of the cap plate 20 to seal between the rivet terminals 21a and 22a of the negative and positive terminals 21 and 22 and the cap plate 20 and electrically insulate therebetween.

The negative electrode gasket 36 and the positive electrode gasket 37 may be further extended between the flanges 21b and 22b and the inner surface of the cap plate 20 to further seal and electrically insulate between the flanges 21b and 22b and the cap plate 20. That is, the negative electrode gasket 36 and the positive electrode gasket 37 may prevent leakage of the electrolyte solution through the terminals H1 and H2 when the negative terminal 21 and the positive terminal 22 are installed in the cap plate 20.

The negative electrode lead tab 51 and the positive electrode lead tab 52 respectively may electrically connect the negative terminal 21 and the positive terminal 22 to the negative electrode 11 and the positive electrode 12 of the electrode assembly 10. The negative electrode lead tab 51 and the positive electrode lead tab 52 may be connected to lower ends of the rivet terminals 21a and 22a while being supported by the flanges 21b and 22b by coupling the negative and positive electrode lead tabs 51 and 52 to the lower ends of the rivet terminals 21a and 22a and caulking the lower ends.

The negative electrode insulation member 61 and the positive electrode insulation member 62 may be provided between the negative electrode lead tab 51 and the positive electrode lead tab 52, respectively, and the cap plate 20 for electric insulation therebetween. In addition, the negative electrode insulation member 61 and the positive electrode insulation member 62 may coupled to the cap plate 20 at one side thereof.

One side of the negative electrode insulation member 61 and the positive electrode insulation member 62 may coupled to the cap plate 20 and another side of the negative electrode insulation member 61 and the positive electrode insulation member 62 may respectively surround the negative electrode lead tab 51, the positive electrode lead tab 52, the rivet terminals 21a and 22a, and the flanges 21b and 22 such that the connection structure therebetween may be stable.

An external insulation member 31 may be provided between the plate terminal 21c at the side of the negative terminal 21 and the cap plate 20 to electrically insulate the plate terminal 21c and the cap plate 20. The cap plate 20 may maintain an electrically insulated state with respect to the negative terminal 21.

A conductive top plate 46 may be provided between the plate terminal 22c at the side of the positive terminal 22 and the cap plate 20 to electrically connect the plate terminal 22c and the cap plate 20. The cap plate 20 may maintain an electrically connected state with the positive terminal 22.

The conductive top plate 46 and the plate terminal 22c may be coupled to an upper end of the rivet terminal 22c and the upper end may be riveted or welded such that the conductive top plate 46 and the plate terminal 22c are fastened to the upper end of the rivet terminal 22a. The plate terminal 22c may be provided in an external side of the cap plate 20 while interposing the conductive top plate 46 therebetween.

The positive electrode gasket 37 may prevent the rivet terminal 22a and the top plate 46 from being directly electrically connected with each other. The rivet terminal 22a may be electrically connected to the conductive top plate 46 through the plate terminal 22c. Thus, the top plate 46 and the case 15 may have positive polarity.

A vent hole 24 may be closed and sealed by a vent plate 25. When the internal pressure of the rechargeable battery reaches a predetermined level, the vent plate 25 may ruptured, and thus, the vent hole 24 may be opened to discharge internal pressure and gas generated in the rechargeable battery. The vent plate 25 may include a notch 25a that induces the rupture.

Referring back to FIG. 3 and FIG. 4, for convenience in description, the structure of the first pressing member 71 will be exemplarily described as a description of the structure of the pressing member 70. The first pressing member 71 may include a first pressing portion 701 and a second pressing portion 702 that support the electrode assembly 10 by pressing. A support portion 703 may provide a pressing force to the first and second pressing portions 701 and 702.

The first pressing portion 701 and the second pressing portion 702 may be formed facing each other, and may press the interface portion 83 and a part of the plane surface portion 82 in a surface contact manner. The support portion 703 may connect the first pressing portion 701 and the second pressing portion 702.

When the first and second pressing portions 701 and 702 are not coupled to the electrode assembly 10 and thus, when the first and second pressing portions 701 and 702 are in a free state, a structure in which a distance between the first pressing portion and the second pressing portion is gradually narrowed toward the opposite side of the support portion 703 from the support portion 703, for example, according to a distance away form the support portion 703 (refer to the imaginary line in FIG. 4) may be formed.

When the first pressing portion 701 and the second pressing portion 702 are coupled to the electrode assembly 10 and thus press the interface portion 83 and the plane surface portion 82, the first and second pressing portions 701 and 702 may respectively form a right angle with the support portion 703 such that the first pressing portion 701 and the second pressing portion 702 may maintain a parallel state. In this case, the first pressing portion 701 and the second pressing portion 702 may press the interface portion 83 of the electrode assembly 10 such that the separator 13 and the negative electrode 11 may be uniformly bonded to each other in the interface therebetween, and the separator 13 and the positive electrode 12 may be uniformly bonded to each other in the interface therebetween.

Accordingly, no gas trap may be formed and no deposition of lithium (Li) salt may occur from the interface of the separator 13 and the negative electrode 11 and the interface of the separator 13 and the positive electrode 12.

A width W2 of each of the first and second pressing portions 701 and 702 may have a predetermined ratio with respect to the entire width W1 of the plane surface portion 82 of the electrode assembly 10. As the ratio of the width W2 of the first and second pressing portions 701 and 702 with respect to the entire width W1 is increased, the pressing force applied to the interface portion 83 is increased and the bonding in the interfaces becomes more uniform, and accordingly, the possibility of deposition of the Li salt from the interfaces may decrease. As the ratio (W2/W1) is decreased, the pressing force applied to the interface portion 83 may be decreased and the bonding in the interfaces may become non-uniform such that possibility of deposition of the Li salt may be increased.

Table 1 represents an average occurrence of Li salt deposition according to the ratio (W2/W1) of the width W2 of the pressing portion with respect to the entire width W1 of the plane surface portion 82.

TABLE 1

| | Average number of times of deposition of lithium salt of more |
|---|---|
| | than 1 mm diameter per electrode assembly (width W1 of |
| | electrode is 155 mm, height is 10 mm, number of times of |
| W2/W1 | winding is 17) |
| 0% | 25 |
| 20% | 16 |
| 40% | 10 |
| 60% | 4 |
| 80% | 2 |
| 100% | 0 |

Referring to Table 1, when the ratio (W2/W2) of the width W2 first and second pressing portions 701 and 702 with respect to the entire width W1 was 100%, that is, when the entire width W1 and the width W2 of each of the first and second pressing portions 701 and 702 are equivalent to each other, the number of times of deposition of lithium salt of more than 1 mm diameter was observed to be zero.

When the ratio (W2/W1) of the width W2 of each of the first and second pressing portions 701 and 702 with respect to the entire width W1 was 0% (that is, the pressing member 70 was not used), the number of times of deposition of lithium salt of more than 1 mm diameter was observed to be 25.

It can be seen from Table 1 that as the ratio (W2/W1) is decreased, the pressing force of the interface portion 83 is weakened, and the bonding in the interface becomes non-uniform. Thus, possibility of deposition of lithium salt is increased.

The support portion 703 of the first pressing portion may include a through-hole 704 that faces the first curved surface portion 811. The through-hole 704 may be formed to correspond to a vent hole 24 provided in a cap plate 20 to stably induce internal gas to the vent hole 24. The through-hole 704 may prevent the passage of internal gas from being interrupted by the first pressing member 71.

Hereinafter, additional exemplary embodiments will be described. Descriptions of parts having been described in the previously described embodiment will not be repeated, and configurations that are different from those of the previously described exemplary embodiment will be described.

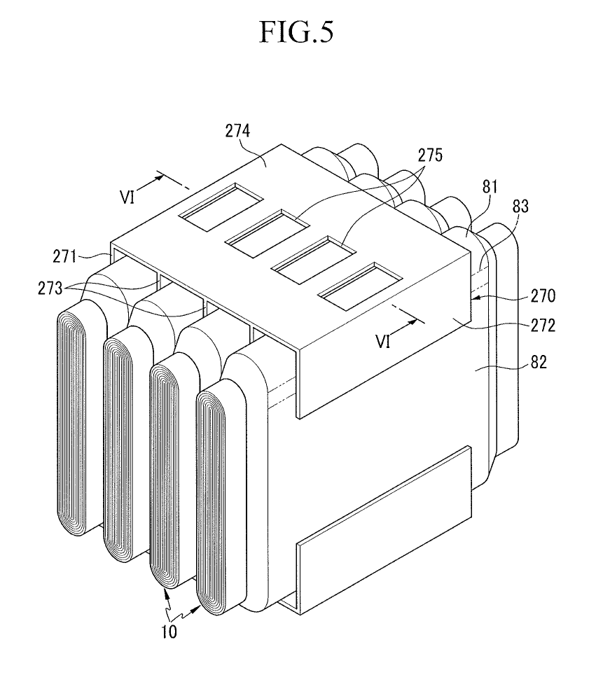

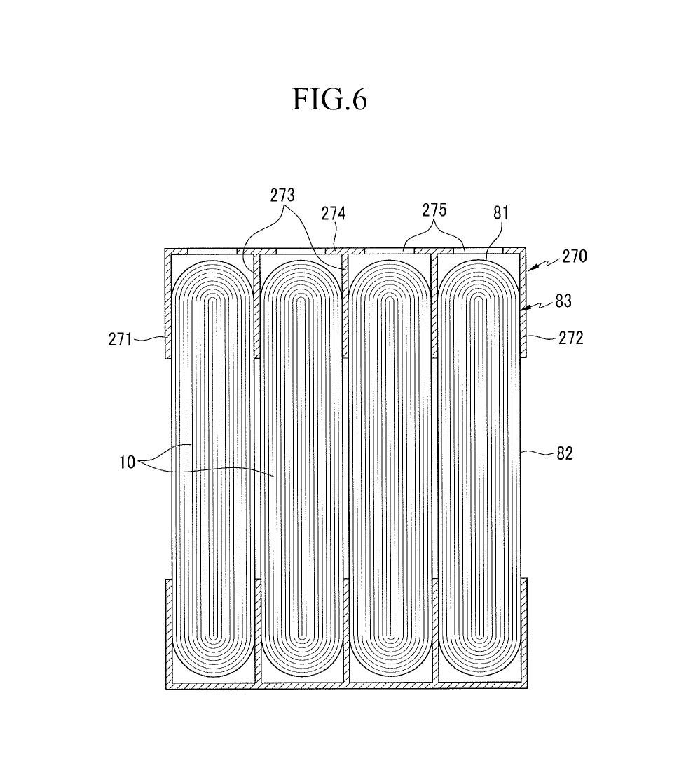

FIG. 5 illustrates a perspective view showing a coupling of an electrode assembly 10 and a pressing member 270 in a rechargeable battery according to another exemplary embodiment, and FIG. 6 illustrates a cross-sectional view of FIG. 5, taken along the line VI-VI.

Referring to FIG. 5 and FIG. 6, in this exemplary embodiment, an electrode assembly 10 is provided in a plural number, and the pressing member 270 is formed to press interface portions 83 in the plurality of electrode assemblies 10.

In the pressing member 270, the first pressing portion 271 and the second pressing portion 272 may press the interface portion 83 and a part of the plane surface portion 82 in a surface contact manner with respect to two electrode assemblies 10 disposed at the outermost sides among the plurality of electrode assemblies 10.

The support portion 274 may provide a pressing force to the first and second pressing portions 271 and 272 by connecting the first pressing portion 271 and the second pressing portion 272. In other implementations, the pressing member 270 may be formed as a first pressing portion, a second pressing portion, and a support portion (not shown) to press the entire interfaces of the plurality of electrode assemblies with the first and second pressing portions.

In this exemplary embodiment, the pressing member 270 may further include third pressing portions 273. The third pressing portions 273 may be connected to the supporting portion 274 between the first pressing portion 271 and the second pressing portion 272, and may be disposed between the plurality of electrode assemblies 10 to partially press the interface portions 83 and the plane surface portions 82 that neighbor to both sides of each of the third pressing portions 271 in a surface contact manner.

In this exemplary embodiment, three of the third pressing portions 273 are illustrated. In other implementations, at least one third pressing portion 273 may be provided. In other implementations, the third pressing portion 273 may be omitted. Compared to a case in which the first and second pressing portions 271 and 272 are provided and the third pressing portions are not provided, when all of the first, second, and third pressing portions 271, 272, and 273 are provided, the respective interface portions of the electrode assemblies 10 may be more uniformly pressed.

The support portion 274 may include through-holes 275 that face curved surface portions 81 of the respective electrode assemblies 10. The pressing member 270 may include through-holes 275 that respectively correspond to the electrode assemblies 10.

The plurality of through-holes 275 may be formed to respectively correspond to a vent hole or vent holes 24 formed in the cap plate 20 to stably induce gas generated from the respective electrode assemblies 10 to the vent hole or vent holes 24. The through-holes 275 may prevent the internal gas from being interrupted by the first, second, third pressing portions 271, 272, and 273, and the support portion 274.

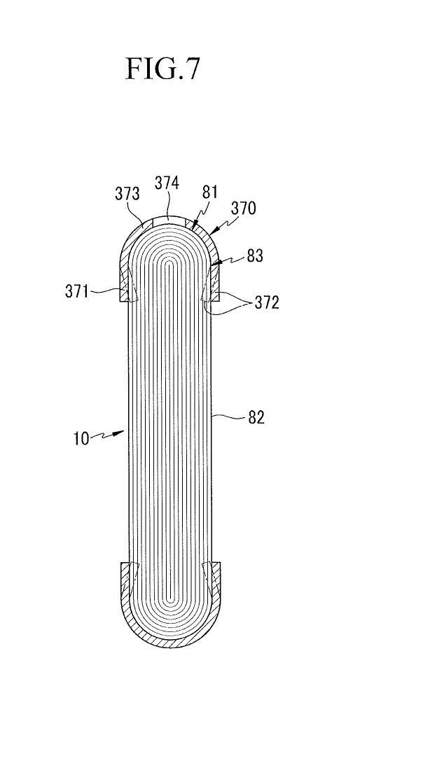

FIG. 7 illustrates a cross-sectional view showing a coupling state of an electrode assembly 10 and a pressing member 370 in a rechargeable battery according to another exemplary embodiment.

Referring to FIG. 7, when first and second pressing portions 371 and 372 are not coupled to the electrode assembly 10 and thus, are in a free state, a structure in which a distance between the first pressing portion 371 and the second pressing portion 372 is gradually narrowed toward the opposite side of a support portion 373 from the support portion 373, for example, according to a distance away form the support portion 373, (refer to the imaginary line in FIG. 7) may be formed.

When the first pressing portion 371 and the second pressing portion 372 are coupled to the electrode assembly 10 and thus press an interface portion 83 and a plane surface portion 82, the first and second pressing portions 371 and 372, which are respectively connected with the support portion 373, may maintain a parallel state between the first pressing portion 371 and the second pressing portion 372.

The support portion 373 may be curved to correspond to the curved surface portion 81 to support the curved surface portion 81 in a surface contact manner. Thus, the support portion 373 may further press the curved surface portion 81 while providing a pressing force to the first and second pressing portions 371 and 372.

The first pressing portion 371 and the second pressing portion 372 may press the interface portion 83 of the electrode assembly 10 and the support portion 373 may press the curved surface portion 81 such that bonding in an interface of a separator 12 and a negative electrode 11 and bonding in an interface of the separator 13 and a positive electrode 12 may be more uniform.

The first pressing portion 371, the support portion 373, and the second pressing portion 372 may be respectively curved with the same thickness along the plane surface portion 82 and the curved surface portion 81 so that a space additionally occupied in the cap plate 20 can be minimized. Accordingly, the pressing member 370 may be effectively received in the case 15. The pressing member 370 may be formed of an elastic material.

The support portion 373 may include a through-hole 374 that faces the curved surface portion 81. The through-hole 374 may be formed corresponding to a vent hole 24 provided in a cap plate 20 to stably induce internal gas to the vent hole 24. The through-hole 374 may prevent the internal gas from being interrupted by the pressing member 370 and the support portion 373.

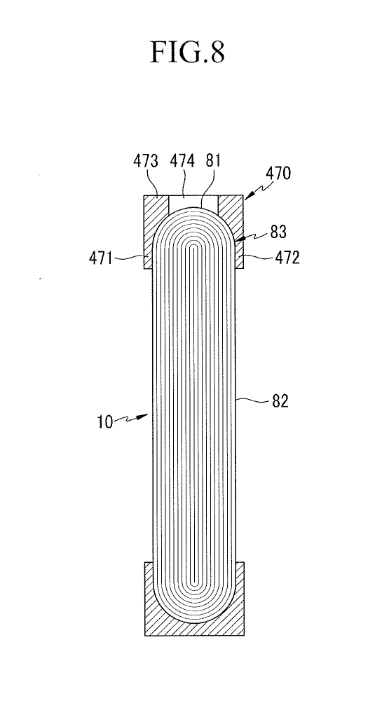

FIG. 8 illustrates a cross-sectional view showing a coupling state of an electrode assembly 10 and a pressing member 470 in a rechargeable battery according to another exemplary embodiment.

Referring to FIG. 8, a first pressing portion 471, a support portion 473, and a second pressing portion 472 may be formed with a small thickness in a plane surface portion 82. The thickness of each of the first pressing portion 471, the support portion 473, and the second pressing portion 472 may gradually increase toward a curved surface portion 81.

In this exemplary embodiment, an inner surface of the pressing member 470 may be curved like the pressing member 370 of the exemplary embodiment illustrated in FIGS. 5 and 6 and an outer surface of the pressing member 470 may be formed to be right-angled, like the pressing member 70 of the exemplary embodiment illustrated in FIGS. 1 through 4. The first pressing portion 471, the support portion 473, and the second pressing portion 472 may press the interface portion 83 and the curved surface portion 81 in a curved manner.

The support portion 473 may include a through-hole 474 that faces toward the curved surface portion 81. The through-hole 474 may correspond to a vent hole 24 provided in a cap plate 20 to stably induce internal gas to the vent hole 24. The through-hole 474 may prevent the internal gas from being interrupted by the pressing member 470 and the support portion 473.

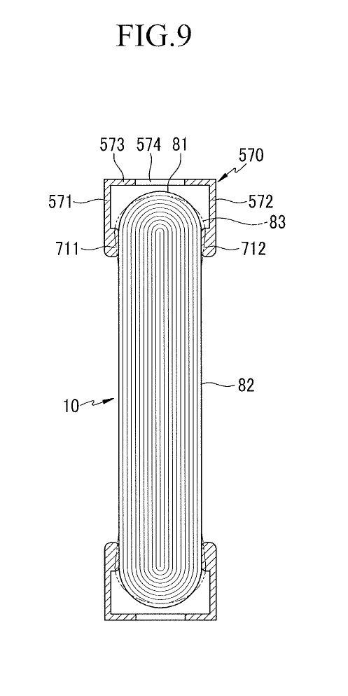

FIG. 9 illustrates a cross-sectional view showing a coupling state of an electrode assembly 20 and a pressing member 570 in a rechargeable battery according to another exemplary embodiment.

A first pressing portion 571 and a second pressing portion 572 may include inner protrusions 711 and 712 that face each other to press an interface portion 83. A support portion 573 may connect the first pressing portion 571 and the second pressing portion 572 to provide a pressing force to the inner protrusions 711 and 712.

The first pressing portion 571 and a second pressing portion 572 may be coupled to the electrode assembly 10 to press the protruding interface portion 83. The interface portion 83 may then be compressed from a state shown by the imaginary line in FIG. 9 to a state shown by the solid line in FIG. 9. In this case, the plane surface portion 82 may be connected to the curved surface portion 81 in a line contact manner. Thus, a separator 13 and a negative electrode 11 may be uniformly bonded to each other in an interface therebetween, and the separator 13 and a positive electrode 13 may be uniformly bonded to each other in an interface therebetween in the electrode assembly 10.

The support portion 573 may include a through-hole 574 that faces the curved surface portion 81. The through-hole 574 may correspond to a vent hole 24 provided in a cap plate 20 to stably induce internal gas to the vent hole 24. The through-hole 574 may prevent the internal gas from being interrupted by the pressing member 570 and the support portion 573.

By way of summation and review, a rechargeable battery may include an electrode assembly performing charging and discharging, a case receiving the electrode assembly therein, and a cap plate coupled to an opening of the case. The electrode assembly may be formed in a jelly roll shape by winding a separator and electrodes disposed in both sides of the separator.

In this case, the electrode assembly includes curved surface portions formed in both sides thereof and a plane surface portion formed between the curved surface portions. The electrode assembly receives strong stress due to a load applied to the plane surface portion in a vertical direction. However, the separator and the electrodes may not be tightly bonded to each other in the curved surface portions so that a relatively weak stress may be applied to the curved surface portions.

Accordingly, the separator and the electrodes may be non-uniformly bonded to each other in an interface portion where the curved surface portions and the plane surface portion are connected to each other. When the interface of the -wound separator and electrodes is non-uniform, an electrolyte solution may be non-uniformly distributed in the non-uniform bonding interfaces of the separator and the electrodes.

The non-uniform distribution of the electrolyte solution may form a gas trap in the non-uniform interface of the separator and the electrodes. The gas trap may cause the bonding in the interfaces of the separator and the electrodes to be more non-uniform, thereby causing the deposition of lithium (Li) salt and deterioration of stability of the battery.

In contrast, embodiments may uniformize bonding at an interface of a separator and an electrode and may prevent deposition of lithium salt in the interface of the separator and the electrode. According to embodiments, at least a part of the curved surface portion and the plane surface portion of the electrode assembly is pressed by a pressing member so that bonding at the interface of the separator and the electrode may be uniform. Accordingly, deposition of lithium salt in the interface of the separator and the electrode may be prevented.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope as set forth in the following claims.

What is claimed is:

1. A rechargeable battery, comprising:
an electrode assembly including a separator and electrode layers on opposite sides of the separator, the electrode assembly being wound such that curved surface portions are at opposing sides of the electrode assembly and a plane surface portion is between the curved surface portions;
a pressing member that presses at least one part of the curved surface portions and the plane surface portion;
a case containing the pressing member and the electrode assembly; and
a cap plate electrically connected to the electrode assembly and coupled to the case.

2. The rechargeable battery as claimed in claim 1, wherein:
the electrode assembly further includes interface portions between the curved surface portions and the plane surface portion, and
the pressing member further includes:
a first pressing portion and a second pressing portion that press respective parts of the interface portions and the plane surface portion in a surface contact manner, the first pressing portion and the second pressing portion facing each other, and
a support portion that connects the first pressing portion and the second pressing portion.

3. The rechargeable battery as claimed in claim 2, wherein the pressing member includes:
a first pressing member coupled to a first curved surface portion at an upper portion of the electrode assembly; and
a second pressing member coupled to a second curved surface portion at a lower portion of the electrode assembly.

4. The rechargeable battery as claimed in claim 3, wherein the support portion of the first pressing member includes a through-hole that faces the first curved surface portion.

5. The rechargeable battery as claimed in claim 2, wherein:
the pressing member has a structure such that, when the first pressing portion and the second pressing portion are in a state of not pressing the respective parts of the interface portions and the plane surface portion, a distance between the first pressing portion and the second pressing portion gradually decreases as a distance from the support portion increases, and when the first pressing portion and the second pressing portions are pressing the respective parts of the interface portions and the plane surface portion, the first pressing portion and the second pressing portion form a right angle with the support portion, and thus, maintain a parallel state therebetween.

6. The rechargeable battery as claimed in claim 2, wherein the support portion is curved to correspond to one curved surface portion of the curved surface portions of the electrode assembly, the support portion supporting the one curved surface portion in a surface contact manner, and the support portion including a through-hole that faces the one curved surface portion.

7. The rechargeable battery as claimed in claim 6, wherein the pressing member has a structure such that, when the first pressing portion and the second pressing portion are in a state of not pressing the respective parts of the interface portions and the plane surface portion, a distance between the first pressing portion and the second pressing portion of the pressing member gradually decreases as a distance from the support portion increases, and when the first pressing portion and the second pressing portion are pressing the respective parts of the interface portions and each plane surface portion, the first pressing member and the second pressing member are parallel.

8. The rechargeable battery as claimed in claim 6, wherein the first pressing portion, the support portion, and the second pressing portion have a same thickness along the plane surface portion and the one curved surface portion.

9. The rechargeable battery as claimed in claim 6, wherein a thickness of each of the first pressing portion, the support portion, and the second pressing portion is gradually increased from the plane surface portion toward the one curved surface portion.

10. The rechargeable battery as claimed in claim 1, wherein:
the electrode assembly further includes interface portions between the curved surface portions and the plane surface portion,
the electrode assembly is provided as a plurality of electrode assemblies, and
the pressing member includes:
a first pressing portion and a second pressing portion that press respective parts of the interface portions and plane surface portion of two electrode assemblies disposed at outermost sides among the plurality of electrode assemblies, and
a support portion connecting the first pressing portion and the second pressing portion in a surface contact manner.

11. The rechargeable battery as claimed in claim 10, wherein the pressing member further includes at least one third pressing portion connected to the support portion between the first pressing portion and the second pressing portion, the third pressing portion extending between two adjacent ones of the electrode assemblies such that two sides of the third pressing portion press facing parts of the interface portions and the plane surface portion of the adjacent ones of the electrode assemblies in a surface contact manner.

12. The rechargeable battery as claimed in claim 11, wherein the support portion of the pressing member includes at least one through-hole that faces toward the curved surface portions of each of the plurality of electrode assemblies.

13. The rechargeable battery as claimed in claim 1, wherein:
the electrode assembly further includes an interface portion between the curved surface portions and the plane surface portions, and
the pressing member includes:
a first pressing portion and a second pressing portion that respectively include inner protrusions that face toward each other and press respective parts of the interface portion, and
a support portion connecting the first pressing portion and the second pressing portion.
